(19) United States
(12) Patent Application Publication
(10) Pub. No.: US 2026/0365120 A1
(43) Pub. Date: Nov. 19, 2026

(54) MAGNETIC HOLDER

(71) Applicant: Shenzhen Baseus Technology Co., Ltd., Shenzhen, Guangdong (CN)

(72) Inventors: Fei ZHOU, Shenzhen (CN); Yuchen ZHENG, Shenzhen (CN)

(73) Assignee: Shenzhen Baseus Technology Co., Ltd., Shenzhen, Guangdong (CN)

(21) Appl. No.: 19/133,433

(22) PCT Filed: Nov. 30, 2023
(86) PCT No.: PCT/CN2023/135539

§ 371 Date: May 28, 2025

(30) Foreign Application Priority Data
Nov. 30, 2022 (CN) 202223207998.1

(51) Int. Cl. B60R 11/02; B60R 11/00; H02J 50/10

(52) U.S. Cl. CPC B60R 11/0241; H02J 50/10; B60R 2011/0005; B60R 2011/0057

(57) ABSTRACT

A magnetic holder, including a supporting assembly, a connection assembly, fasteners and a fixing member, wherein the supporting assembly comprises a cover plate, a magnet, a supporting member provided with a first recess, and a bottom plate provided with protruding portions, the connection assembly comprises a flexible metal plate and flexible glue covering part of the flexible metal plate; the fasteners pass through the protruding portions and connecting holes of the supporting member to fixedly connect the supporting member to the bottom plate; one end of the connection assembly is fixedly connected to the bottom plate, and the other end of the connection assembly is provided with the fixing member; the magnet is fixedly arranged in the first recess and is covered with the cover plate; and a mobile device is fixed to the cover plate by using the attraction of the magnet.

### CROSS-REFERENCE TO RELATED APPLICATION

This application claims priority to Chinese Patent Application No. 202223207998.1 filed on Nov. 30, 2022, the disclosure of which is hereby incorporated by reference in its entirety.

### TECHNICAL FIELD

The present disclosure belongs to the technical field of holders, and in particular relates to a magnetic holder.

### BACKGROUND

In a process of driving a vehicle, people usually need to use a mobile device for navigation. Thus, a vehicle mounted holder for fixing the mobile device to the vehicle is created. In the related art, usually, one end of a mobile device holder is provided with a magnet to attach a mobile phone to a magnetic holder, and another end of the magnetic holder is provided with an adhesive to bond and fix the holder near a vehicle dashboard. The interior of the integrated holder has a flexible metal extending from one end of the mobile phone holder to the other end of the mobile phone holder, and flexible plastic is wrapped around the exterior of the integrated holder. Such a holder has simple and complete appearance and may be bent and adjusted to a suitable angle for use. However, when the holder is bent, a gap may appear at the junction between the mobile phone holder and the mobile phone due to the bending deformation at the junction, which affects the user experience.

### SUMMARY

In view of this, the main object of the present disclosure is to provide a magnetic holder, so as to solve the problem that a gap may appear at the junction between the mobile phone holder and the mobile phone due to the bending deformation at the junction, which affects the user experience.

In order to achieve the above object, the technical solution of the present disclosure is realized as follows.

The present disclosure provides a magnetic holder, which includes a supporting assembly, a connection assembly, a fastener, and a fixing member.

The supporting assembly includes a cover plate, a magnet, a supporting member provided with a first recess, and a bottom plate provided with at least one protrusion. The at least one protrusion and the supporting member together define a connecting hole. The supporting member is located between the cover plate and the bottom plate. The cover plate is configured to fix the magnet in the first recess.

The connection assembly includes a flexible metal plate and a flexible rubber covering a portion of the flexible metal plate. One end of the flexible metal plate is fixed to the bottom plate and is provided with a clearance hole. The clearance hole is configured to avoid the interference with the at least one protrusion. The flexible rubber extends from another end of the flexible metal plate to the clearance hole.

The fastener passes through the connecting hole to fix the supporting member to the bottom plate.

The fixing member is located at an end of the connection assembly away from the clearance hole, and the fixing member is fixedly connected to the connection assembly.

The supporting member and the bottom plate are made of an ABS or PC material.

In one example, the fixing member includes a first connecting portion and a second connecting portion. The second connecting portion is provided with a third adhesive portion and a second adhesive portion which are removable. The third adhesive portion is configured to connect one side of the second connecting portion with the connection assembly, and the second adhesive portion is configured to connect another side of the second connecting portion with one side of the first connecting portion. Another side of the first connecting portion away from the second adhesive portion is provided with an adhesive patch, the adhesive patch is provided with a first bonding part which is removable and is configured for bonding.

In one example, a bonding strength of the third adhesive portion is greater than a bonding strength of the second adhesive portion, and the bonding strength of the second adhesive portion is greater than a bonding strength of the first bonding part.

In one example, the bottom plate is provided with a receiving groove. The receiving groove is configured to receive the flexible rubber arranged at an end of the connection assembly away from the fixing member.

In one example, the bottom plate is provided with a plurality of protrusions spaced apart from each other.

In one example, the supporting member is provided with an annular step recess, and the cover plate is arranged in the step recess.

In one example, a first cavity is formed between the supporting member and the bottom plate. The first cavity is configured to install a PCB board.

In one example, a second cavity is formed between the supporting member and the cover plate. The second cavity is configured to install a charging coil.

In one example, the supporting member is further provided with a partition. The partition is configured to separate the second cavity from the first recess, and the first recess is located outside the second cavity.

In one example, the magnetic holder further includes a magnetic sheet. The magnetic sheet is arranged in the first recess, and the magnetic sheet is located between the magnet and the supporting member.

The present disclosure provides a magnetic holder. The magnetic holder includes a supporting assembly, a connection assembly, a fastener, and a fixing member. The supporting assembly includes a cover plate, a magnet, a supporting member provided with a first recess, and a bottom plate provided with at least one protrusion. The connection assembly includes a flexible metal plate and a flexible rubber covering a portion of the flexible metal plate. The fastener passes through the connecting holes of the protrusion and the supporting member to fixedly connect the supporting member to the bottom plate. The flexible metal plate is provided with a clearance hole configured to avoid the interference with the protrusion, so as to fixedly connect an end of the flexible metal plate provided with the clearance hole to the bottom plate. The fixing member is located at an end of the connection assembly away from the clearance hole, and the fixing member is configured to fix and adhere the magnetic holder at a preset position. The magnet is fixed in the first recess, and the magnet is covered by the cover plate, so as to prevent the magnet from being exposed to the outside, so that the mobile device is fixed on the cover plate by the attraction action of the magnet. The supporting member and the bottom plate are made of an ABS or PC material. When the connection assembly is bent by a user to perform a position adjustment, the supporting assembly would not undergo the bending deformation along with the bending of the connection assembly, so as to ensure that the mobile device is stably connected to the supporting assembly.

### BRIEF DESCRIPTION OF THE DRAWINGS

FIG. 1 is a schematic view of a magnetic holder according to an embodiment of the present disclosure;

FIG. 2 is an exploded view of FIG. 1;

FIG. 3 is an exploded view of a supporting assembly according to an embodiment of the present disclosure;

FIG. 4 is a cross-sectional view of a magnetic holder according to an embodiment of the present disclosure;

FIG. 5 is an enlarged view at A in FIG. 4;

FIG. 6 is an enlarged view at B in FIG. 4;

FIG. 7 is an exploded view of a supporting member, a bottom plate and a connection assembly according to an embodiment of the present disclosure; and

FIG. 8 is a cross-sectional view of a supporting member, a cover plate, a magnet, a magnetic sheet, a charging coil and a filling plate according to an embodiment of the present disclosure.

### DESCRIPTION OF REFERENCE NUMERALS

1. magnetic holder; 10. supporting assembly; 101. cover plate; 102. magnet; 103. supporting member; 1031. first recess; 1032. connecting hole; 1033. annular step recess; 1034. partition; 104. bottom plate; 1041. protrusion; 1042. receiving groove; 11. connection assembly; 111. flexible metal plate; 112. flexible rubber; 1111. clearance hole; 12. fastener; 13. fixing member; 131. first connecting portion; 1311. first bonding part; 132. second connecting portion; 1321. third adhesive portion; 1322. second adhesive portion; 14. first cavity; 15. second cavity; 16. PCB board; 17. charging coil; 18. filling plate; 19. magnetic sheet; 20. charging port.

### DETAILED DESCRIPTION

In order to make the objectives, technical solutions and advantages of the present disclosure clearer, the present disclosure are further described in details below in combination with the accompanying drawings and the embodiments. It should be understood that the specific embodiments described here are merely to explain the present disclosure but not intended to limit the present disclosure.

The various specific technical features described in the specific embodiments can be combined in any suitable way, without contradiction, for example, the combination of different specific technical features may form different embodiments and technical solutions. In order to avoid unnecessary repetition, various possible combinations of the various specific technical features in the present disclosure will not be explained separately.

In the following description, the related terms “first/second . . . ” are only used to distinguish different objects, without indicating similarities or connections between these objects. It should be understood that the related orientation descriptions “above”, “below”, “outer”, and “inner” are all orientations in the normal use state. The “left” and “right” directions represent the left and right directions indicated in the corresponding schematic figure, which may or may not be the left and right direction in the normal use state.

It should be noted that, terms “include”, “comprise” or any other variants thereof are intended to cover non-exclusive inclusion, so that a process, a method, an article or a device including a series of elements not only includes those elements, but also includes other elements that are not explicitly listed, or also include elements inherent to the process, the method, the article, or the device. In the case that there are no more limitations, an element defined by the phrase “including a . . . ” does not exclude the existence of other same elements in the process, the method, the article, or the device that includes the element. Without specific description, the term “connect” may include direct connection and indirect connection.

In the related art, the interior of the mobile device holder is provided with a flexible metal and a flexible rubber covering the flexible metal, a magnet is mounted at one end of the flexible metal, and glue is provided at the bottom portion of the flexible rubber at another end of the flexible metal. The driver mounts the mobile device at the magnet end of the magnetic holder, and fixes the magnetic holder near a vehicle dashboard by using glue, while controlling the bending position of the flexible metal so that the driver can view the mobile device. However, this holder adopts a large area of flexible material, and there is no obvious distinction between the bending area and the holding area (an area that remains unchanged), resulting in that when the holder is bent, bending deformation is also generated on the contact surface between the holder and the mobile device, which affects the stability of connection between the mobile device and the holder.

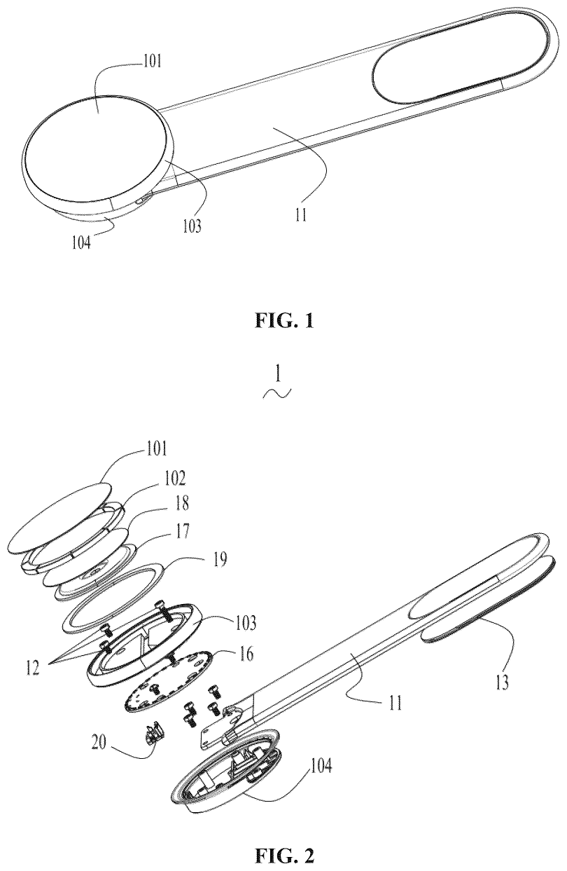

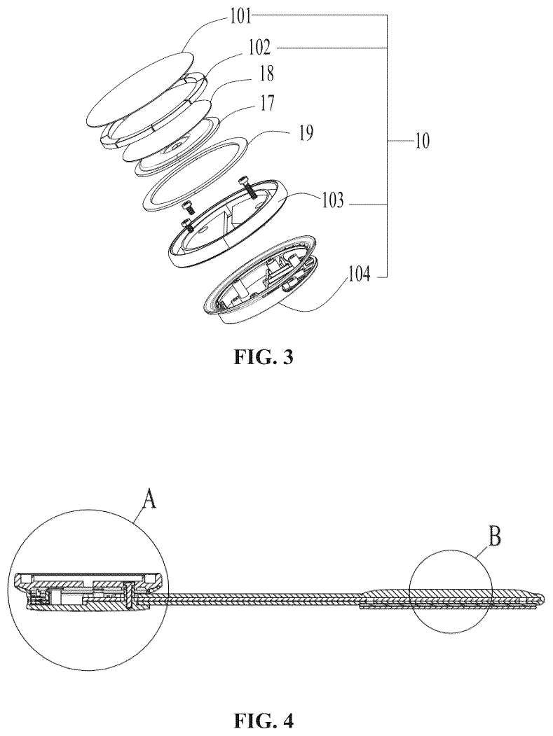

In view of this, as shown in FIG. 1 to FIG. 7, the present disclosure provides a magnetic holder 1. This magnetic holder 1 includes a supporting assembly 10, a connection assembly 11, a fastener 12, and a fixing member 13. The supporting assembly 10 includes a cover plate 101, a cover magnet 102, a supporting member 103 provided with a first recess 1031, and a bottom plate 104 provided with at least one protrusion 1041. The at least one protrusion 1041 and the supporting member 103 together define a connecting hole 1032. The supporting member 103 is located between the cover plate 101 and the bottom plate 104. The cover plate 101 is configured to fix the magnet 102 in the first recess 1031. The connection assembly 11 includes a flexible metal plate 111 and a flexible rubber 112 covering a portion of the flexible metal plate 111. One end of the flexible metal plate 111 is fixed to the bottom plate 104 and is provided with a clearance hole 111. The clearance hole 111 is configured to avoid interference with the at least one protrusion 1041. The flexible rubber 112 extends from another end of the flexible metal plate 111 to the clearance hole 1111. The fastener 12 passes through the connecting hole 1032 to fix the supporting member 103 to the bottom plate 104. The fixing member 13 is located at an end of the connection assembly 11 away from the clearance hole 1111, and the fixing member 13 is fixedly connected to the connection assembly 11. The supporting member 103 and the bottom plate 104 are made of an ABS or PC material.

In particular, the supporting assembly 10 includes a cover plate 101, a magnet 102, a supporting member 103 provided with a first recess 1031, and a bottom plate 104 provided with at least one protrusion 1041. The magnet 102 is mounted in the first recess 1031, the cover plate 101 is fixedly connected to an upper surface of the supporting member 103, and the cover plate 101 abuts against the magnet 102, so that the magnet 102 is fixed in the first recess 1031. The cover plate 101 covers the magnet 102, which plays a decorative role on the entire magnetic holder 1, and prevents the exposure of the magnet 102 to affect the appearance. Optionally, the cover plate 101 may be made of silicone material. When the mobile device is connected to the cover plate 101, the silicone material provides a certain anti-slip function, so that the mobile device is not easy to slip from the cover plate 101. In addition, the silicone material may also protect the magnet 102, so as to prevent other objects from directly colliding with the magnet 102 and damaging the magnet 102. The protrusion 1041 of the bottom plate 104 and the supporting member 103 together define a connecting hole 1032. The fastener 12 passes through the connecting hole 1032 to fix the supporting member 103 to the bottom plate 104. For example, a portion of the connecting hole 1032 at the protrusion 1041 is a through hole, a portion of the connecting hole 1032 at the supporting member 103 is a threaded hole, and the fastener 12 is a bolt, so that the bolt passes through the through hole of the protrusion 1041 and is connected with the threaded hole of the supporting member 103, so as to fixedly connect the supporting member 103 to the bottom plate. In another example, the portion of the connecting hole 1032 at the protrusion 1041 and the portion of the connecting hole 1032 at the supporting member 103 are through holes which pass through the protrusion 1041 and the supporting member 103 respectively, and the fastener 12 is a bolt and a nut, so that the bolt passes through each of the through holes of the protrusion 1041 and the supporting member 103, so as to fixedly connect the supporting member 103 to the bottom plate by bolt-nut connection.

The connection assembly 11 includes a flexible metal plate 111 and a flexible rubber 112 covering a portion of the flexible metal plate 111. One end of the flexible metal plate 111 is fixed to the bottom plate 104. Optionally, the connection between the flexible metal plate and the bottom plate may be achieved by threaded connection or bonding. For example, four through holes are provided on the flexible metal plate 111, and four threaded holes are provided on the bottom plate 104, so that four bolts pass through the four through holes and are connected to the four threaded holes, respectively, so as to fixedly connect an end of the flexible metal plate 111 to the bottom plate 104. In another example, strong glue is uniformly applied onto a connection plane of the flexible metal plate 111 and the bottom plate 104 to bond and fix the flexible metal plate 111 to the bottom plate 104, thereby reducing the assembly processes. Another end of the flexible metal plate 111 is provided with a clearance hole 1111. The clearance hole is configured to avoid the interference with the protrusion 1041 of the bottom plate 104, so as to mount the flexible metal plate 111 on the bottom plate 104. The flexible rubber 112 extends from the other end of the flexible metal plate 111 to the clearance hole 1111. The flexible rubber 112 protects the flexible metal plate 111 and improves the ductility of the flexible metal plate 111.

The fixing member 13 is provided at an end of the connection assembly 11 away from the clearance hole 1111. One side of the fixing member 13 is provided with glue for bonding the fixing member 13 to the end of the connection assembly 11 away from the clearance hole 1111. Another side of the fixing member 13 is provided with a removable bonding part for fixing the magnetic holder 1 near the vehicle dashboard.

It should be noted that, the material of each of the supporting member 103 and the bottom plate 104 is selected from an ABS or PC material, so that a hardness of each of the supporting member 103 and the bottom plate 104 is much greater than a hardness of the flexible metal plate 111. When the bending angle of the connection assembly 11 is adjusted by the user, the supporting member 103 and the bottom plate 104 will not generate the bending deformation along with the bending of the connection assembly 11, and the bending deformation will not be generated at the contact surface between the cover plate 101 of the supporting assembly 10 and the mobile device, so as to avoid the degradation in stability of connection between the supporting assembly 10 and the mobile device from.

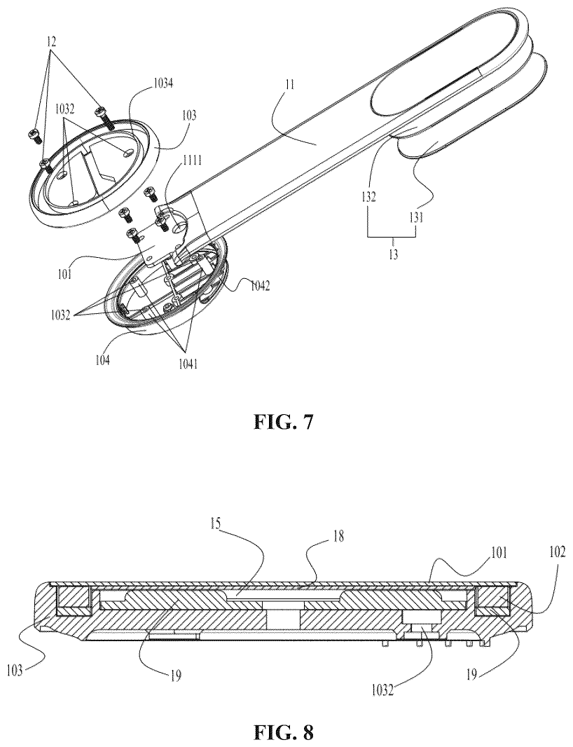

In an embodiment, as shown in FIG. 6 and FIG. 7, the fixing member 13 includes a first connecting portion 131 and a second connecting portion 132. The second connecting portion 132 is provided with a third adhesive portion 1321 and a second adhesive portion 1322 which are removable. The third adhesive portion 1321 is configured to connect one side of the second connecting portion 132 with the connection assembly 11, and the second adhesive portion 1322 is configured to connect another side of the second connecting portion 132 with one side of the first connecting portion 131. Another side of the first connecting portion 131 away from the second adhesive portion 1322 is provided with an adhesive patch. The adhesive patch is provided with a first bonding part 1311 which is removable and is configured for bonding. In particular, the third adhesive portion 1321 on the side of the second connecting portion 132 is bonded to the end of the connection assembly 11 away from the clearance hole 1111 of the flexible metal plate 111, so as to fixedly connect the second connecting portion 132 to the connection assembly 11. Then, one side of the first connecting portion 131 is bonded to the second adhesive portion 1322 of the second connecting portion 132, so as to fix the first connecting portion 131 to the second connecting portion 132. The removable first bonding part 1311 is provided on the side of the first connecting portion 131 away from the second adhesive portion 1322. The first bonding part 1311 is provided with a tearable film. When it is necessary to fix the first bonding part 1311 at a preset position, the tearable film is first torn, and then the first bonding part can be adhered. The tearable film may protect the first bonding part 1311 and prevent dust, dirt, or the like from affecting the bonding strength of the first bonding part 1311.

In an embodiment, as shown in FIG. 6, a bonding strength of the third adhesive portion 1321 is greater than a bonding strength of the second adhesive portion 1322, and the bonding strength of the second adhesive portion 1322 is greater than a bonding strength of the first bonding part 1311. In particular, as shown in FIG. 6 and FIG. 7, the third adhesive portion 1321 is configured to fixedly connect the connection assembly 11 to the second connecting portion 132, the second adhesive portion 1322 is configured to fixedly connect the second connecting portion 132 to the first connecting portion 131, and the first bonding part 1311 is configured to fix the magnetic holder 1. When the first bonding part 1311 is bonded at the preset position and the user needs to move the magnetic holder 1, the user may grip a middle position of the connection assembly 11 to move the magnetic holder 11 away from the bonding position. Since the bonding strength of the first bonding part 1311 is smaller than the bonding strength of each of the second adhesive portion 1322 and the third adhesive portion 1321, only the first bonding part 1311 is torn from the bonding position. Meanwhile, the first bonding part 1311 has been used once. In order to prevent dust, dirt, or the like from affecting the adhesive force of the first bonding part 1311, the first connecting portion 131 is torn from the second adhesive portion 1322, and the second adhesive portion 1322 of the second connecting portion 132 is used for adhesion, so that the magnetic holder 1 is fixed again. During removal of the first connecting portion 131, since the bonding strength of the second adhesive portion 1322 is smaller than the bonding strength of the third adhesive portion 1321, the second connecting portion 132 will not be detached from the connection assembly 11 along with the first connecting portion 131. It should be noted that, the third adhesive portion 1321 may also be provided at the bottom portion of the end of the connection assembly 11 away from the clearance hole 1111. When the user needs to move the magnetic holder 1 for the second time, the first connecting portion 131 is torn from the connection assembly 11, and then the third adhesive portion 1321 of the connection assembly 11 is used for adhesion.

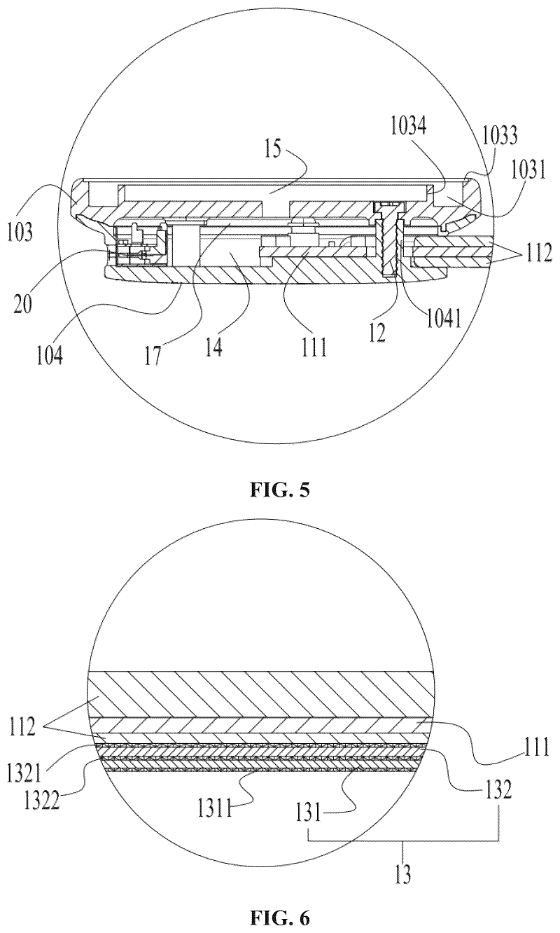

In an embodiment, as shown in FIG. 5 and FIG. 7, the bottom plate 104 is provided with a receiving groove 1042. The receiving groove 1042 is configured to receive the flexible rubber 112 arranged at an end of the connection assembly 11 away from the fixing member 13. In particular, the flexible rubber 112 covering the flexible metal plate 111 extends from one end of the flexible metal plate 111 to the clearance hole 1111 of the flexible metal plate 111, and the area of the flexible metal plate 111 extending from the clearance hole 1111 to another end of the flexible metal plate 111 is not covered with the flexible rubber 112, this area being configured to fix the flexible metal plate 111 to the bottom plate 104. Since the flexible rubber 112 has a certain thickness, the receiving groove 1042 for receiving a portion of the flexible rubber 112 at the end of the connection assembly 11 away from the fixing member 13 is provided on the bottom plate 104, so as to prevent the portion of the flexible metal plate 111 which is not covered with the flexible rubber 112 from being exposed to outside.

In an embodiment, as shown in FIG. 7, there are a plurality of protrusions 1041, and the plurality of protrusions 1041 are spaced apart from each other. In particular, the bottom plate 104 is provided with a plurality of protrusions 1041 distributed at intervals. For example, the bottom plate 104 is provided with three protrusions 1041 arranged in a circumferential direction. One of the protrusions 1041 passes through the clearance hole 1111 of the flexible metal plate 111, for mounting and positioning the end of the flexible metal plate 111 provided with the clearance hole 1111. It should be noted that, in this example, the bottom plate 104 is provided with three protrusions 1041, and the supporting member 103 is provided with three connecting holes 1032. The number of the connecting holes 1032 is the same as the number of the protrusions 1041. The position of each connecting hole 1032 matches the position of the respective protrusion 1041, and the bolts are connected to the portions of the three connecting holes 1032 at the three protrusions 1041 through the portions of the three connecting holes 1032 at the supporting member, so as to fixedly connect the supporting member 103 to the bottom plate 104. Providing the three protrusions 1041 improves the stability of connection between the supporting member 103 and the bottom plate 104.

In an embodiment, as shown in FIG. 5, the supporting member 103 is provided with an annular step recess 1033, and the cover plate 101 is arranged in the annular step recess 1033. In particular, an upper surface of the supporting member 103 is provided with the annular step recess 1033, in which the glue is uniformly filled, and then the cover plate 101 is fixedly mounted in the annular step recess 1033.

In an embodiment, as shown in FIG. 2, FIG. 5 and FIG. 8, a first cavity 14 is formed between the supporting member 103 and the bottom plate 104. The first cavity 14 is configured to install a PCB board 16. In particular, after the supporting member 103 is fixedly connected to the bottom plate 104, the first cavity 14 is formed between the supporting member 103 and the bottom plate 104. The bottom plate 104 is provided with an annular mounting groove in an area of the first cavity 14, and the PCB board 16 is provided with two through holes. The PCB board 16 is placed in the annular mounting groove, and then the PCB is fixedly connected to raised studs on the bottom plate 104 by two bolts, so that the PCB board 16 is mounted in the first cavity 14. It should be noted that, the PCB board 16 is further provided with three through holes of the PCB board 16. The three through holes of the PCB board 16 are configured to avoid the interference with three bolts which fix the supporting member to the protrusions of the bottom plate 104.

In an embodiment, as shown in FIG. 5 and FIG. 8, a second cavity 15 is formed between the supporting member 103 and the cover plate 101. The second cavity 15 is configured to install a charging coil 17. In particular, the second cavity 15 is formed after the cover plate 101 is mounted on the upper surface of the supporting member 103. The second cavity 15 has a cylindrical shape for mounting the charging coil 17. The mounting processes of the cover plate 101, the charging coil 17 and the supporting member 103 are as follows. The supporting member 103 is first fixedly mounted on the bottom plate 104, then the charging coil 17 is mounted in the second cavity 15, and finally the cover plate 101 is fixedly mounted on the upper surface of the supporting member 103, so as to cover the charging coil 17. A filling plate 18 is further provided between the charging coil 17 and the cover plate 101. The filling plate 18 is configured to fill the gap between the charging coil 17 and the cover plate 101. The filling plate 18 may be optionally made of a flexible rubber to protect the charging coil 17. In particular, the charging coil 17 is mounted in the second cavity 15 through snap connection or bonding. For example, a diameter of a bottom portion of the charging coil 17 is 2 mm larger than a diameter of the second cavity 15, so that an interference fit is formed between the bottom portion of the charging coil 17 and a bottom portion of the second cavity 15. For example, the glue is uniformly provided on an end surface of the bottom portion of the second cavity 15, and then the charging coil 17 is bonded to the end surface of the bottom portion of the second cavity 15. It should be noted that, a charging port 20 is further provided in the second cavity. When the magnetic holder is fixed at the preset position, the mobile device is placed on the cover plate 101, and a charger is connected to the charging port 20, so that wireless charging may also be performed when the mobile device is fixed on the magnetic holder 1.

In an embodiment, as shown in FIG. 5 and FIG. 8, the supporting member 103 is further provided with a partition 1034. The partition 1034 is configured to separate the second cavity 15 from the first recess 1031, and the first recess 1031 is located outside the second cavity 15. In particular, the partition 1034 is provided between the first recess 1031 and the second cavity 15. The partition 1034 has a circular ring shape and is configured to separate the first recess 1031 from the second cavity 15, so as to avoid collision between the cover magnet 102 mounted in the first recess 1031 and the charging coil 17 mounted in the second cavity 15.

In an embodiment, as shown in FIG. 8, the magnetic holder 1 further includes a magnetic sheet 19. The magnetic sheet 19 is arranged in the first recess 1031, and the magnetic sheet 19 is located between the cover magnet 102 and the supporting member 103. In particular, the magnetic sheet 19 forms an interference fit with a bottom end of the first recess 1031 to fix the magnetic sheet 19 at the bottom end of the first recess 1031, and then the cover magnet 102 is attached to one side of the magnetic sheet 19 away from the bottom end of the first recess 1031 by magnetic attraction, so as to facilitate the attachment and fixation of the cover magnet 102 in the first recess 1031 by magnetic attraction. In particular, the magnetic sheet 19 is a magnetic metal sheet. After the magnetic sheet 19 is fixed to the bottom end of the first recess 1031, the cover magnet 102 is removably attached to the magnetic sheet 19 by magnetic attraction.

The above embodiments are merely used for describing rather than limiting the technical solutions of the present disclosure. Although the present disclosure is described in detail with reference to the foregoing embodiments, for those skilled in the art, the technical solutions specified in the above embodiments can still be modified, or some of the technical features therein can be equivalently substituted; and such modifications or substitutions do not make the essence of the corresponding technical solutions depart from the spirit and the scope of the technical solutions of the present disclosure.

1. A magnetic holder, comprising:
a supporting assembly comprising a cover plate, a magnet, a supporting member provided with a first recess, and a bottom plate provided with at least one protrusion, wherein the at least one protrusion and the supporting member together define a connecting hole, the supporting member being located between the cover plate and the bottom plate, the cover plate being configured to fix the magnet in the first recess;
a connection assembly comprising a flexible metal plate and a flexible rubber covering a portion of the flexible metal plate, wherein one end of the flexible metal plate is fixed to the bottom plate and is provided with a clearance hole, the clearance hole being configured to avoid an interference with the at least one protrusion, the flexible rubber extending from another end of the flexible metal plate to the clearance hole;
a fastener, wherein the fastener passes through the connecting hole to fix the supporting member to the bottom plate; and
a fixing member located at an end of the connection assembly away from the clearance hole, the fixing member being fixedly connected to the connection assembly,
wherein the supporting member and the bottom plate are made of an ABS or PC material.

2. The magnetic holder according to claim 1, wherein the fixing member comprises a first connecting portion and a second connecting portion, wherein the second connecting portion is provided with a third adhesive portion and a second adhesive portion which are removable, the third adhesive portion being configured to connect one side of the second connecting portion with the connection assembly, and the second adhesive portion being configured to connect another side of the second connecting portion with one side of the first connecting portion; and wherein another side of the first connecting portion away from the second adhesive portion is provided with an adhesive patch, the adhesive patch being provided with a first bonding part which is removable and is configured for bonding.

3. The magnetic holder according to claim 2, wherein a bonding strength of the third adhesive portion is greater than a bonding strength of the second adhesive portion, and the bonding strength of the second adhesive portion is greater than a bonding strength of the first bonding part.

4. The magnetic holder according to claim 1, wherein the bottom plate is provided with a receiving groove, wherein the receiving groove is configured to receive the flexible rubber arranged at an end of the connection assembly away from the fixing member.

5. The magnetic holder according to claim 1, wherein the bottom plate is provided with a plurality of protrusions spaced apart from each other.

6. The magnetic holder according to claim 1, wherein the supporting member is provided with an annular step recess, and the cover plate is arranged in the step recess.

7. The magnetic holder according to claim 1, wherein a first cavity is formed between the supporting member and the bottom plate, wherein the first cavity is configured to install a PCB board.

8. The magnetic holder according to claim 1, wherein a second cavity is formed between the supporting member and the cover plate, wherein the second cavity is configured to install a charging coil.

9. The magnetic holder according to claim 8, wherein the supporting member is further provided with a partition, wherein the partition is configured to separate the second cavity from the first recess, and the first recess is located outside the second cavity.

10. The magnetic holder according to claim 1, wherein the magnetic holder further comprises a magnetic sheet, wherein the magnetic sheet is arranged in the first recess, and the magnetic sheet is located between the magnet and the supporting member.

11. The magnetic holder according to claim 1, wherein the cover plate is made of silicone material.

12. The magnetic holder according to claim 1, wherein a portion of the connecting hole at the at least one protrusion is a through hole, a portion of the connecting hole at the supporting member is a threaded hole, and the fastener is a bolt, wherein the bolt passes through the through hole of the at least one protrusion and is connected with the threaded hole of the supporting member to fixedly connect the supporting member to the bottom plate.

13. The magnetic holder according to claim 1, wherein a portion of the connecting hole at the at least one protrusion and a portion of the connecting hole at the supporting member are through holes which pass through the at least one protrusion and the supporting member respectively, and the fastener is a bolt and a nut, wherein the bolt passes through each of the through holes of the at least one protrusion and the supporting member to fixedly connect the supporting member to the bottom plate by bolt-nut connection.

14. The magnetic holder according to claim 1, wherein a hardness of each of the supporting member and the bottom plate is much greater than a hardness of the flexible metal plate.

15. The magnetic holder according to claim 2, wherein the first bonding part is provided with a tearable film.

16. The magnetic holder according to claim 5, wherein the bottom plate is provided with three protrusions arranged in a circumferential direction, and one of the three protrusions passes through the clearance hole of the flexible metal plate.

17. The magnetic holder according to claim 6, wherein an upper surface of the supporting member is provided with the annular step recess, and glue is uniformly filled in the annular step recess.

18. The magnetic holder according to claim 8, wherein a filling plate is provided between the charging coil and the cover plate, wherein the filling plate is configured to fill a gap between the charging coil and the cover plate.

19. The magnetic holder according to claim 8, wherein a charging port is provided in the second cavity.

20. The magnetic holder according to claim 10, wherein the magnet is removably attached to the magnetic sheet by magnetic attraction.
